(19) United States
(12) Patent Application Publication
(10) Pub. No.: US 2005/0217438 A1
(43) Pub. Date: Oct. 6, 2005

(54) Grip member for wrench

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/978,592

(22) Filed: Nov. 1, 2004

(30) Foreign Application Priority Data
Apr. 6, 2004 (TW) 93109420

(51) Int. Cl. B25B 23/16

(52) U.S. Cl. 81/177.1

(57) ABSTRACT

A wrench includes a body and a grip member. The body includes a head on an end thereof and a handle on another end thereof. The handle includes two opposed sidewalls and a recessed portion between the sidewalls. The handle further includes a grasping section, with the recessed portion being at least partially located in the grasping section. The grip member is securely attached to the recessed portion of the handle. Thus, the driving force from the user can be effectively transmitted to the head of the body, as the sidewalls of the handle withstand most part of the driving force. Preferably, each sidewall of the handle extends across a central line of a height of the combined handle/grip member.

### BACKGROUND OF THE INVENTION

1. Field of the Invention

The present invention relates to a wrench. In particular, the present invention relates to a grip member for a wrench.

2. Description of the Related Art

Wrenches play an important role in daily life. FIGS. 14 and 15 of the drawings illustrate a conventional wrench 40 including a head 41 on an end thereof and a handle 43 on the other end thereof. To reduce the overall weight of the wrench, the wrench 40 has a recessed portion 44 extending from the head 41 through the handle 43 made of metal, and a plastic grip member 45 is bonded by gluing to a section 42 of the recessed portion 44 in the handle 43. The bonding area between the grip member 45 and the handle 43 is planar. Further, a periphery of the handle 43 extends through an area smaller than a half of an overall periphery of the combined grip member 45/handle 43. Hence, when a user grasps the combined grip member 45/handle 43 and drives a fastener, most part of the force from the hand of the user is imparted to the grip member 45, resulting an increase in the gap between the grip member 45 and the handle 43. In some cases, the grip member 45 would disengage from the handle 43 after long-term use.

### SUMMARY OF THE INVENTION

In accordance with an aspect of the present invention, a wrench comprises a body and a grip member. The body comprises a head on an end thereof and a handle on another end thereof. The handle includes two opposed sidewalls and a recessed portion between the sidewalls. The handle further includes a grasping section, with the recessed portion being at least partially located in the grasping section. The grip member is securely attached to the recessed portion of the handle. Thus, the driving force from the user can be effectively transmitted to the head of the body, as the sidewalls of the handle withstand most part of the driving force. As a result, undesired displacement of the grip member is less likely to occur even after long-term use of the wrench. Disengagement of the grip member from the body is avoided.

Each sidewall of the handle extends across a central line of a height of the combined handle/grip member.

Each sidewall of the handle may be curved. Each sidewall of the handle may have a reduced height not extending across the central line at a section outside the grasping section. The grip member includes a raised portion securely engaged with the recessed portion of the handle.

In an embodiment of the invention, the recessed portion includes at least one screw hole in a bottom wall thereof. The raised portion of the grip member includes at least one through-hole aligned with the screw hole. A fastener extends through the through-hole of the grip member and threadedly engaged with the screw hole. The through-hole of the grip member includes a shoulder, and the fastener is a bolt having a head abutting against the shoulder. A seal may be mounted in the through-hole of the grip member. The seal may be a ball having a diameter slightly greater than that of the through-hole of the grip member.

In another embodiment of the invention, the recessed portion includes a slot in a bottom wall thereof. A decorative strip is securely mounted in the slot of the recessed portion. The decorative strip includes at least one screw hole. The raised portion of the grip member includes at least one through-hole aligned with the screw hole. A fastener extends through the through-hole of the grip member and threadedly engaged with the screw hole. Preferably, the recessed portion extends across the central line of the height of the combined handle/grip. Preferably, the slot has a longitudinal length smaller than that of the recessed portion.

In a further embodiment of the invention, the recessed portion includes at least one through-hole in a bottom wall thereof. The raised portion of the grip member includes at least one snapping fastener engaged with the through-hole of the recessed portion.

In still another embodiment of the invention, the recessed portion includes at least one through-hole in a bottom wall thereof. The raised portion of the grip member includes at least one receptacle aligned with the through-hole of the recessed portion. A fastener extends through the through-hole of the recessed portion and the receptacle of the grip member. The fastener is bonded with the grip member by high frequency welding.

In accordance with another aspect of the invention, a wrench comprises a body, a decorative strip, and a grip member. The body comprises a head on an end thereof and a handle on another end thereof. The handle includes two opposed sidewalls and a through-hole between the sidewalls. The handle further includes a grasping section. The through-hole is at least partially located in the grasping section and extends from an upper side of the handle through a bottom side of the handle.

The decorative strip is mounted in an upper portion of the through-hole of the handle. The grip member is partially mounted in a lower portion of the through-hole of the handle and securely engaged with the decorative strip. Each sidewall of the handle extends across a central line of a height of the combined handle/grip member. The recessed portion extends across the central line of the height of the combined handle/grip.

Preferably, the slot has a longitudinal length smaller than that of the recessed portion.

In an embodiment, the through-hole includes a necked portion and the decorative strip includes a reduced section mounted in the necked portion.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a perspective view of a first embodiment of a wrench in accordance with the present invention.

FIG. 2 is a perspective view, partly exploded, of the wrench in FIG. 1.

FIG. 3 is a bottom perspective view of the wrench in FIG. 1.

FIG. 4 is a sectional view taken along plane 4-4 in FIG. 1.

FIG. 5 is perspective view of a perspective view of a second embodiment of the wrench in accordance with the present invention.

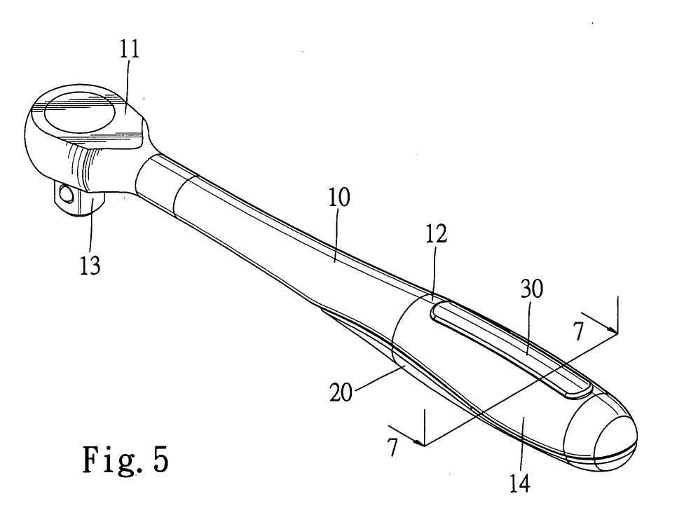

FIG. 6 is a perspective view, partly exploded, of the wrench in FIG. 5.

FIG. 7 a sectional view taken along plane 7-7 in FIG. 5.

FIG. 8 is a perspective view, partly exploded, of a third embodiment of the wrench in accordance with the present invention.

FIG. 9 is a sectional view of the wrench in FIG. 8.

FIG. 10 a perspective view, partly exploded, of a fourth embodiment of the wrench in accordance with the present invention.

FIG. 11 is a sectional view of the wrench in FIG. 10.

FIG. 12 is a sectional view illustrating a fifth embodiment of the wrench in accordance with the present invention.

FIG. 13 is a perspective view illustrating use of the wrench in accordance with the present invention.

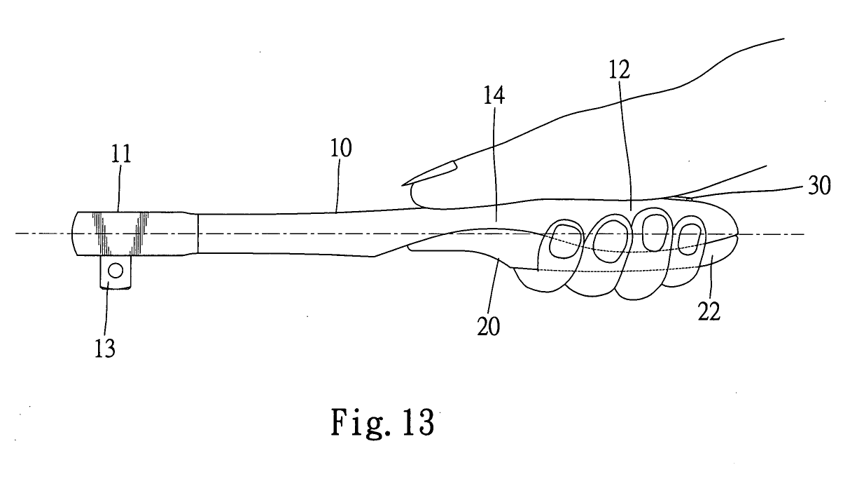

FIG. 14 is a perspective view, partly exploded, of a conventional wrench.

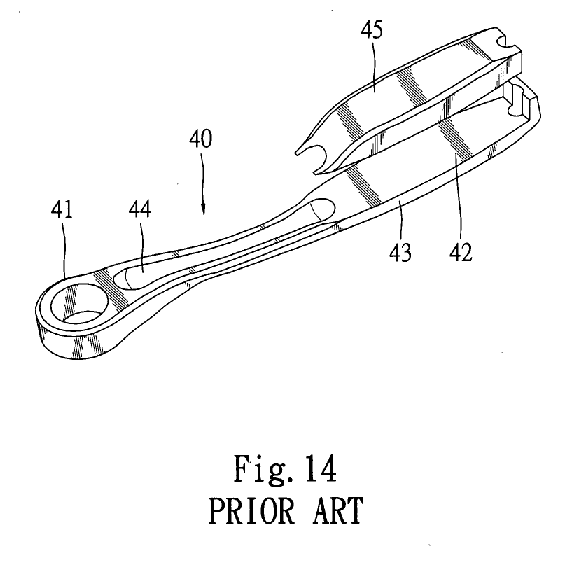

FIG. 15 is a side view of the wrench in FIG. 14.

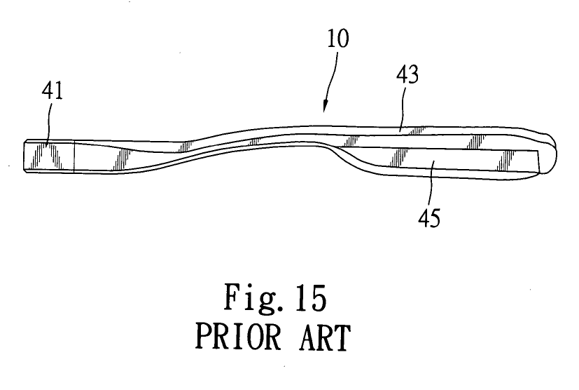

### DETAILED DESCRIPTION OF THE PREFERRED EMBODIMENTS

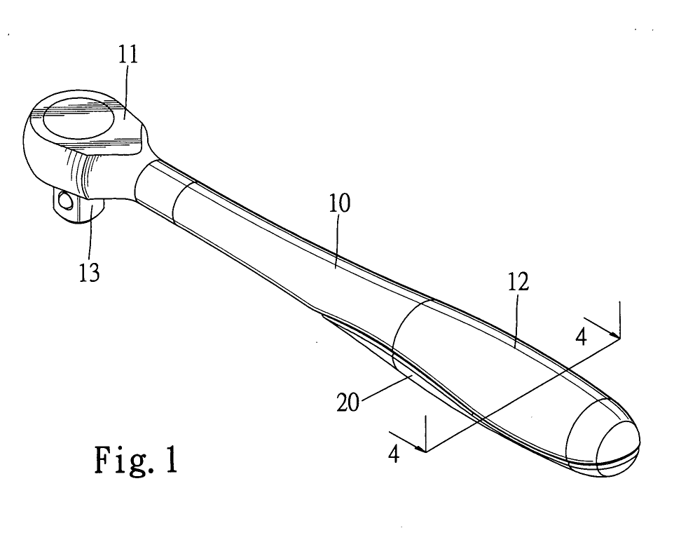

FIGS. 1 through 4 illustrate a first embodiment of a wrench in accordance with the present invention. The wrench includes a body 10 and a grip member 20. The body 10 includes a head 11 on an end thereof and a handle 12 on the other end thereof. In this embodiment, the head 11 includes a drive column 13 for driving fasteners (not shown) such as bolts, screws, etc. Further, a mechanism (not shown) for controlling a ratcheting direction for driving the fastener and a free rotating direction not driving the fastener can be mounted in the head 11.

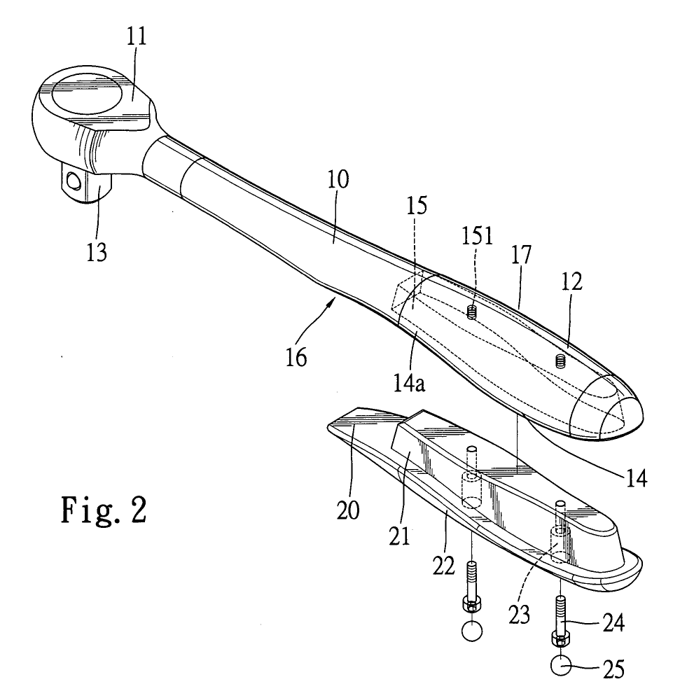

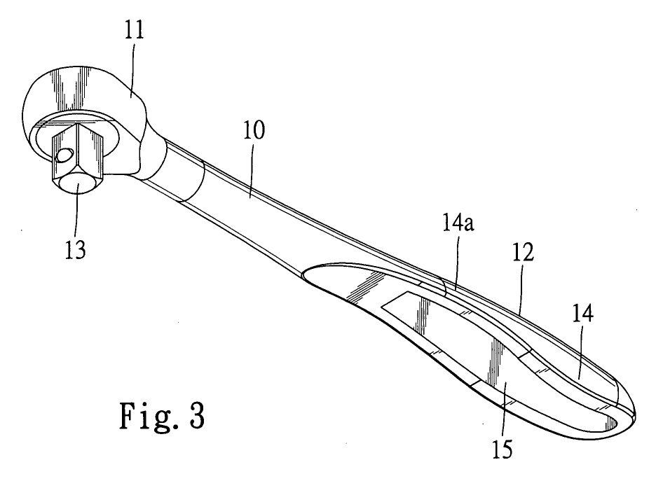

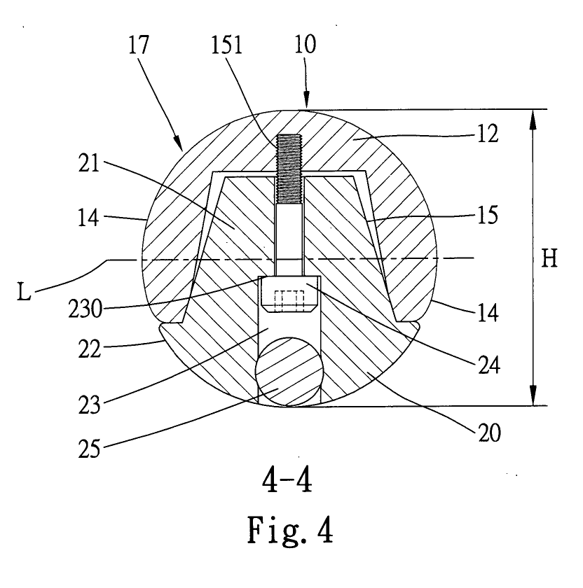

Still referring to FIGS. 1 and 2 and further to FIGS. 3 and 4, the handle 12 of the body 10 is made by forging a metal rod to form a perimeter 16 with two opposed sidewalls 14. The handle 12 further includes a recessed portion 15 between the sidewalls 14. As illustrated in FIGS. 1 and 4, the handle 12 includes a grasping section 17 for user's grip. The recessed portion 15 is at least partially located in the grasping section 17. Namely, the recessed portion 15 may extend forward beyond the grasping section 17. Each of the sidewalls 14 at the grasping section 17 extends across a central line L of a height H (FIG. 4) of the combined handle 12/grip member 20. The height H of the combined handle 12/grip member 20 is substantially orthogonal to a plane on which the wrench turns while driving a fastener. Further, at least one screw hole 151 (two in this embodiment) is defined in a bottom wall delimiting the recessed portion 15. Preferably, the recessed portion 15 extends across the central line L of the height H of the combined handle/grip 12 and 20. The recessed portion 15 in the illustrated embodiment is in an underside of the handle 12. In an alternative embodiment, the recessed portion 15 is defined in an upper side of the handle 12.

It is noted that the sidewalls 14 at the other section (i.e., outside the grasping section 17, see section 14a) of the handle 12 may not extend across the central line L orthogonal to the height H of the combined handle 12/grip member 20. As illustrated in FIGS. 2 and 3, each sidewall 14 is curved and has a reduced height not extending across the central line L at the section 14a outside the grasping section 17. This may save more metal material of the handle 12.

The grip member 20 is made of a material that is cheaper and lighter than the metal material for the handle. Preferably, the grip member 20 is made of plastics. The grip member 20 includes a raised portion 21 on an inner side thereof. The grip member 20 further includes at least one through-hole 23 (two in this embodiment) extending from an outer side of the grip member 20 through the inner side of the grip member 20. Each through-hole 23 has a shoulder or stepped portion 230 (FIG. 4).

As illustrated in FIG. 4, the grip member 20 is engaged to the grasping section 17 of the handle 12 with the raised portion 21 of the grip member 20 being engaged with the recessed portion 15. A fastener (e.g., a bolt 24) is mounted in each through-hole 23 of the grip member 20 and threadedly engaged with an associated screw hole 151 of the handle 10, with the bolt head (not labeled) of each bolt 24 abutting against the shoulder 230 of the associated through-hole 23. A seal 25 is mounted in each through-hole 23 to seal the through-hole 23, providing an aesthetic appearance. In this embodiment, the seal 25 is a ball with a diameter slightly greater than that of the through-hole 23 of the grip member 20.

The grip member 20 has two opposite sidewalls 22 having curvatures corresponding to those of the sidewalls 14 of the handle 12. The sidewalls 14 and 22 are ergonomically streamlined for easy grip by the user.

As illustrated in FIG. 4, since each sidewall 14 at the grasping section 17 extends across the central line L of the height H (FIG. 4) of the combined handle 12/grip member 20, the sidewalls 14 of the handle 12 withstand most part of the driving force from the user. Since the sidewalls 14 are an integral part of the body 10 formed by means of forging steel, the driving force can be effectively transmitted to the head 11 of the body 10. Thus, undesired displacement of the grip member 20 is less likely to occur even after long-term use of the wrench. Disengagement of the grip member 20 from the body 10 is avoided.

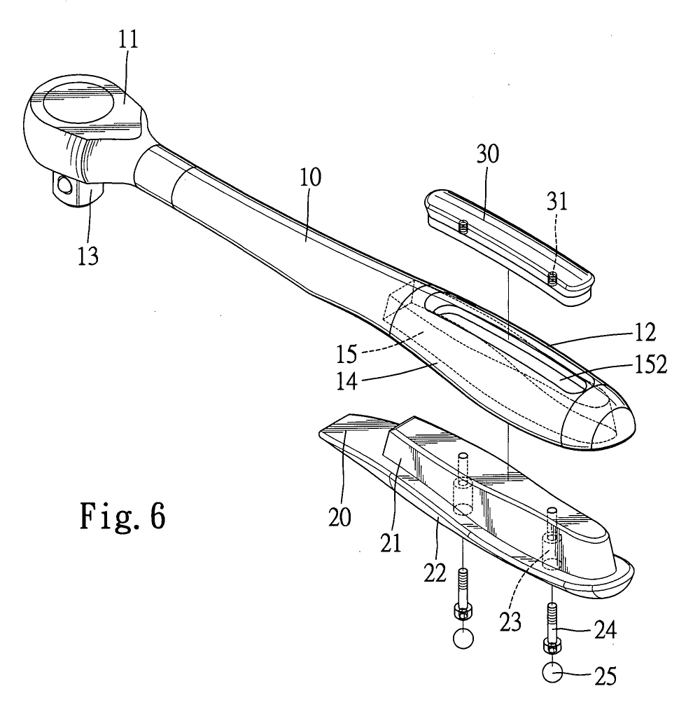

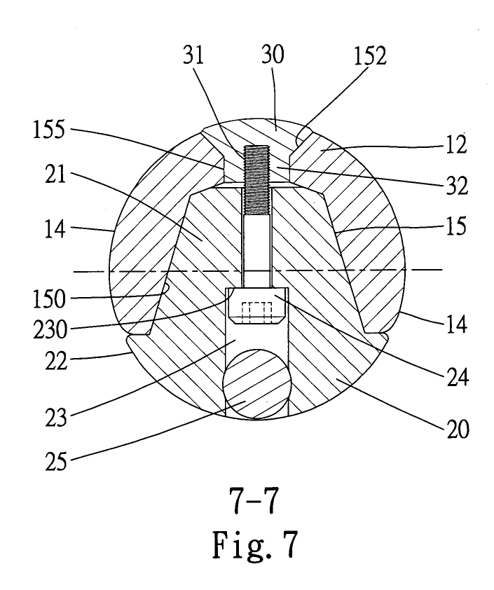

FIGS. 6 and 7 illustrate a second embodiment of the invention, wherein a slot 152 (with a conic outer end in this embodiment) is defined in the bottom wall of the recessed portion 15. The recessed portion 15 extends across the central line L of the height H of the combined handle/grip 12 and 20. Further, the slot 152 has a longitudinal length smaller than that of the recessed portion 15. A decorative strip 30 is securely mounted in the slot 152 and includes two screw holes 31 for engaging with the bolts 24. The decorative strip 30 provides added value to the wrench while preventing disengagement of the grip member 20. In other words, a through-hole 150 extending from an upper side of the handle 12 through a bottom side of the handle 12 is provided in this embodiment, with a decorative strip 30 and a grip member 20 being accommodated in the through-hole 150 and securely engaged with each other. It is note that the grip member 20 is partially accommodated in the through-hole 150 of the handle 12 and that the through-hole 150 includes a necked portion 155 for receiving a reduced section 32 of the decorative strip 30.

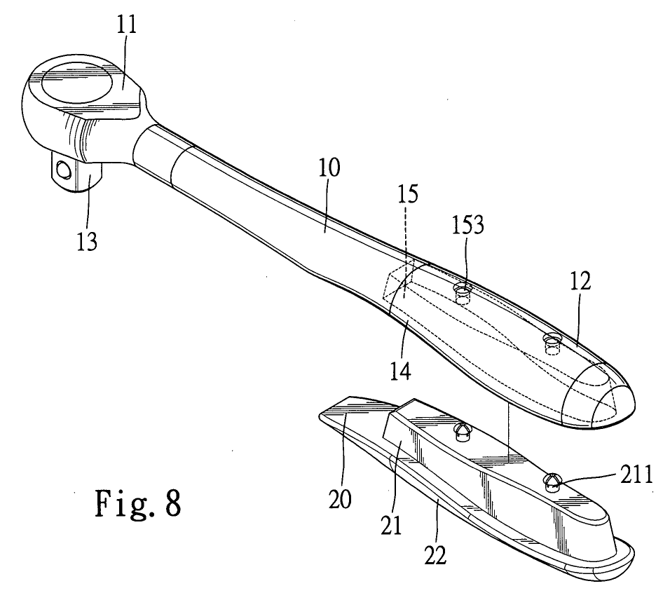

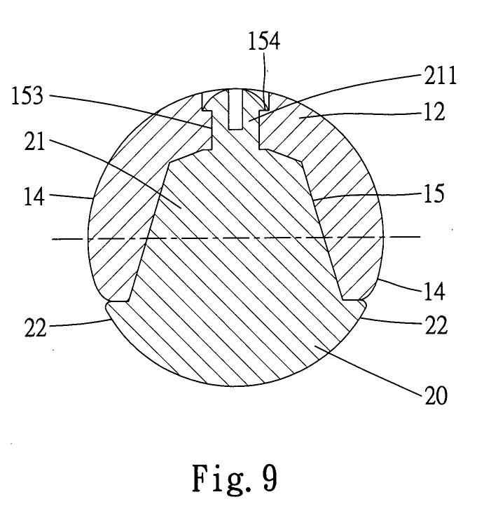

FIGS. 8 and 9 illustrate a third embodiment of the invention, wherein the bottom wall of the recessed portion 15 includes two through-holes 153 each having an enlarged portion 154 (FIG. 9). The through-holes 23 in the first embodiment are omitted. Instead, the raised portion 21 includes two snapping fasteners 211 for snapping engagement with the through-holes 153. Thus, the grip member 20 can be securely mounted to the handle 12 of the body 10 while achieving the same function.

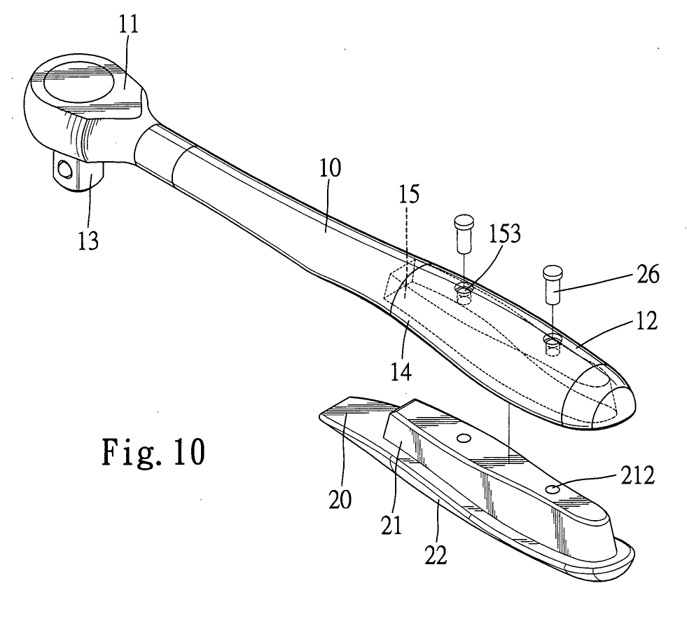

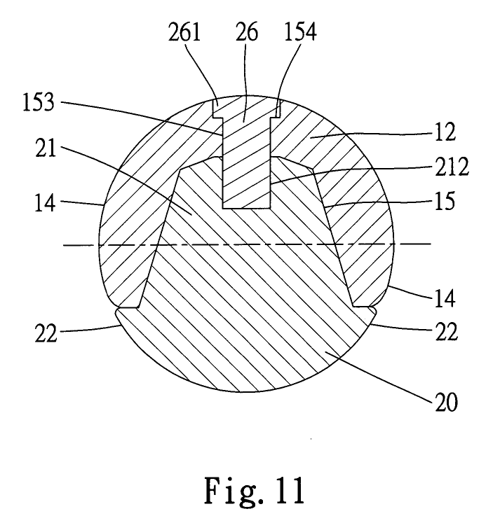

FIGS. 10 and 11 illustrate a fourth embodiment modified from the third embodiment. In this embodiment, the raised portion 21 of the grip member 20 includes two receptacles 212 in an inner face thereof. The bottom wall of the recessed portion 15 includes two through-holes 153 each having an enlarged portion 154 (FIG. 11). Two fasteners 26 are extended through the through-holes 153 of the handle 12 into the receptacles 212 of the grip member 20. Each fastener 26 has a head 261 received in the associated enlarged portion 154. Each fastener 26 is then bonded with the grip member 20 by high frequency welding.

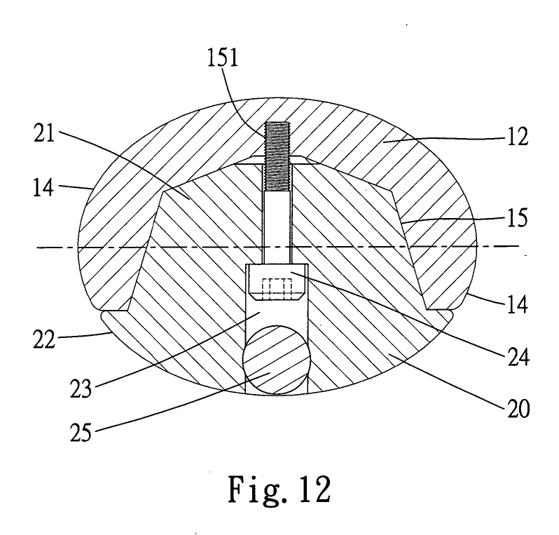

FIG. 12 illustrates a fifth embodiment of the invention, wherein the handle 12 and the grip member 20 are substantially elliptic after assembly.

Although the invention has been explained in relation to its preferred embodiments, it is to be understood that many other possible modifications and variations can be made without departing from the scope of the invention as hereinafter claimed.

1. A wrench comprising:
a body comprising a head on an end thereof and a handle on another end thereof, the handle including two opposed sidewalls and a recessed portion between the sidewalls, the handle further including a grasping section, with the recessed portion being at least partially located in the grasping section; and
a grip member securely attached to the recessed portion of the handle.

2. The wrench as claimed in claim 1, with each said sidewall of the handle being curved.

3. The wrench as claimed in claim 1, with each said sidewall of the handle having a reduced height not extending across the central line at a section outside the grasping section.

4. The wrench as claimed in claim 1, with the grip member including a raised portion securely engaged with the recessed portion of the handle.

5. The wrench as claimed in claim 4, with the recessed portion including at least one screw hole defined in a bottom wall of the recessed portion, with the raised portion of the grip member including at least one through-hole aligned with said at least one screw hole, and with at least one fastener extending through said at least one through-hole of the grip member and threadedly engaged with said at least one screw hole.

6. The wrench as claimed in claim 5, with said at least one through-hole of the grip member including a shoulder, with said at least one fastener being a bolt having a head abutting against the shoulder.

7. The wrench as claimed in claim 6, with the wrench further including at least one seal mounted in said at least one through-hole of the grip member.

8. The wrench as claimed in claim 7, with said at least one seal being a ball having a diameter slightly greater than that of said at least one through-hole of the grip member.

9. The wrench as claimed in claim 4, with the recessed portion including a slot defined in a bottom wall of the recessed portion, with the wrench further including a decorative strip securely mounted in the slot of the recessed portion, with the decorative strip including at least one screw hole, with the raised portion of the grip member including at least one through-hole aligned with said at least one screw hole, and with at least one fastener extending through said at least one through-hole of the grip member and threadedly engaged with said at least one screw hole.

10. The wrench as claimed in claim 9, with said at least one through-hole of the grip member including a shoulder, with said at least one fastener being a bolt having a head abutting against the shoulder.

11. The wrench as claimed in claim 10, with the wrench further including at least one seal mounted in said at least one through-hole of the grip member.

12. The wrench as claimed in claim 11, with said at least one seal being a ball having a diameter slightly greater than that of said at least one through-hole of the grip member.

13. The wrench as claimed in claim 1, with the recessed portion extending across a central line of a height of the combined handle/grip.

14. The wrench as claimed in claim 13, with the slot having a longitudinal length smaller than that of the recessed portion.

15. The wrench as claimed in claim 4, with the recessed portion including at least one through-hole defined in a bottom wall of the recessed portion, with the raised portion of the grip member including at least one snapping fastener engaged with said at least one through-hole of the recessed portion.

16. The wrench as claimed in claim 4, with the recessed portion including at least one through-hole defined in a bottom wall of the recessed portion, with the raised portion of the grip member including at least one receptacle aligned with said at least one through-hole of the recessed portion, with the wrench further including at least one fastener extending through said at least one through-hole of the recessed portion and said at least one receptacle of the grip member, with said at least one fastener being bonded with the grip member by high frequency welding.

17. The wrench as claimed in claim 1, with each said sidewall of the handle extending across a central line of a height of the combined handle/grip member.

18. A wrench comprising:
a body comprising a head on an end thereof and a handle on another end thereof, the handle including two opposed sidewalls and a through-hole between the sidewalls, the handle further including a grasping section, with the through-hole being at least partially located in the grasping section and extending from an upper side of the handle through a bottom side of the handle, the through-hole including an upper portion and a lower portion;
a decorative strip mounted in the upper portion of the through-hole of the handle; and
a grip member partially mounted in the lower portion of the through-hole of the handle and securely engaged with the decorative strip;
each said sidewall of the handle extending across a central line of a height of the combined handle/grip member;
the recessed portion extending across the central line of the height of the combined handle/grip.

19. The wrench as claimed in claim 18, with the grip member including a raised portion engaged with the lower portion of the through-hole of the handle.

20. The wrench as claimed in claim 19, with the decorative strip including at least one screw hole, with the raised portion of the grip member including at least one through-hole aligned with said at least one screw hole, and with at least one fastener extending through said at least one through-hole of the grip member and threadedly engaged with said at least one screw hole.

21. The wrench as claimed in claim 20, with said at least one through-hole of the grip member including a shoulder, with said at least one fastener being a bolt having a head abutting against the shoulder.

22. The wrench as claimed in claim 21, with the wrench further including at least one seal mounted in said at least one through-hole of the grip member.

23. The wrench as claimed in claim 18, with the through-hole including a necked portion and with the decorative strip including a reduced section mounted in the necked portion.

24. The wrench as claimed in claim 18, with the slot having a longitudinal length smaller than that of the recessed portion.
